(19) United States
(12) Patent Application Publication
(10) Pub. No.: US 2022/0182305 A1
(43) Pub. Date: Jun. 9, 2022

(54) Request Processing System and Method Thereof

(71) Applicant: Shenzhen Chenbei Technology Co., Ltd., Shenzhen (CN)

(72) Inventor: Huifeng Tang, Shenzhen (CN)

(21) Appl. No.: 17/457,898

(22) Filed: Dec. 6, 2021

(30) Foreign Application Priority Data
Dec. 7, 2020 (CN) 202011415615.2

(51) Int. Cl. H04L 43/0852; H04L 43/16; H04L 67/62

(52) U.S. Cl. CPC H04L 43/0852; H04L 67/325; H04L 43/16

(57) ABSTRACT

A method of processing request for a network system includes the steps of: (a) receiving a parent request by a second network node from a first network node, the parent request including a first request time; (b) acquiring a first remaining time by the second network node, the first remaining time being the time left for processing the parent request; (c) determining a first overrun time by the second network node, the first overrun time being determined by the first request time, the first remaining time and a first receipt time of the parent request, the first receipt time being the time the parent request is received by the second network node, and (d) aborting processing of the parent request by the second network node when the time lapsed between the first receipt time and a current time is equal to or greater than the overrun time.

### CROSS REFERENCE TO RELATED APPLICATION

This is a non-provisional application which claims priority to a Chinese patent application having an application number of CN202011415615.2, and a filing date of Dec. 7, 2020, the entire contents of which is hereby incorporated by reference.

### BACKGROUND OF THE PRESENT INVENTION

### Field of Invention

The present invention relates to Internet technology, and more particularly to a method of processing requests and a system implementing this method.

### Description of Related Arts

With the rapid development of doing business over Internet, various systems are developed to specialize in different specific areas. For example, microservice architecture and container technology may actually be supported by a vast variety of different services such as a many back-end services, so that a simple service request from a terminal may involve many services before it can be completed.

In order to improve system fault tolerance, and minimize the time for recovering a fault system, conventional network systems may comprise a timeout detection mechanism in which a timeout request will not be further processed by any services. Convention services may have a predetermined timeout period, so that when a request has been processed for that timeout period, the request processing will be aborted and a corresponding timeout message will be generated in the relevant terminal, such as a client terminal or a service terminal. However, situations may arise where when the request has become timeout, some back-end services may continue processing the request and the result of those back-end processing will not be able to be transmitted back to the front-end service terminal such as the service terminal or the client terminal. As a result, the computing resources used by the back-end services will be wasted because the results of those back-end services will never be utilized.

### SUMMARY OF THE PRESENT INVENTION

Certain variations of the present invention provide a method of processing requests and a system implementing this method for minimizing waste of sources when a network system processes requests.

In one aspect of the present invention, it provides a method of processing request for a network system, comprising the steps of:

(a) receiving a parent request by a second network node from a first network node, the parent request including a first request time;

(b) acquiring a first remaining time by the second network node, the first remaining time being the time left for processing the parent request;

(c) determining a first overrun time by the second network node, the first overrun time being determined by the first request time, the first remaining time and a first receipt time of the parent request, the first receipt time being the time the parent request is received by the second network node, and

(d) aborting processing of the parent request by the second network node when the time lapsed between the first receipt time and a current time is equal to or greater than the overrun time.

In another aspect of the present invention, it provides a request processing system, comprising:

a first network node configured to generate and transmit a parent request; and

a second network node communicated with the first network node, the second network node being configured to:

receive a parent request transmitted from the first network node, the parent request including a first request time, the first request time being a time at which the parent requested is generated;

acquire a first remaining time, the first remaining time being the time left for processing the parent request;

determine a first overrun time, the first overrun time being determined by the first request time, the first remaining time and a first receipt time of the parent request, the first receipt time being the time the parent request is received by the second network node; and

abort processing of the parent request when a time lapsed between the first receipt time and a current time is equal to or greater than the overrun time, the first overrun time being a time period threshold that the parent request is processed.

This summary presented above is provided merely to introduce certain concepts and not to identify any key or essential features of the claimed subject matter.

### BRIEF DESCRIPTION OF THE DRAWINGS

FIG. 1 is block diagram illustrating a method of method of processing request for a network system according to a preferred embodiment of the present invention.

FIG. 2 is a schematic diagram illustrating the method of method of processing request for a network system according to the preferred embodiment of the present invention.

FIG. 3 is a block diagram illustrating a request processing system according to the preferred embodiment of the present invention.

FIG. 4 is another block diagram of a request processing system according to the preferred embodiment of the present invention, illustrating that the request processing system can be implemented in a network system.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

It should be appreciated that the terms “length”, “width”, “top”, “bottom”, “front”, “rear”, “left”, “right”, vertical”, “horizontal”, “upper”, “lower”, “exterior”, and “interior” in the following description refer to the orientation or positioning relationship in the accompanying drawings for easy understanding of the present invention without limiting the actual location or orientation of the present invention. Therefore, the above terms should not be an actual location limitation of the elements of the present invention.

It should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection can refer to permanent connection or detachable connection. Therefore, the above terms should not be an actual connection limitation of the elements of the present invention.

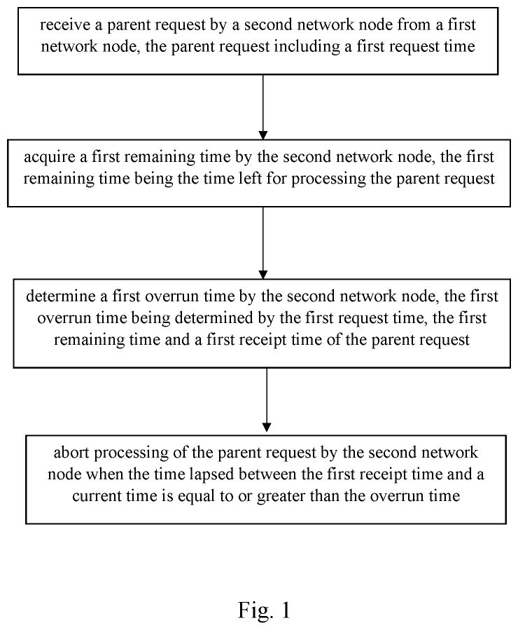

Referring to FIG. 1 of the drawings, a method of processing request for a network system according to a preferred embodiment of the present invention is illustrated. The method may comprise the steps of:

(a) receiving a parent request by a second network node from a first network node, the parent request including a first request time;

(b) acquiring a first remaining time by the second network node, the first remaining time being the time left for processing the parent request;

(c) determining a first overrun time by the second network node, the first overrun time being determined by the first request time, the first remaining time and a first receipt time of the parent request, the first receipt time being the time the parent request is received by the second network node, and

(d) aborting processing of the parent request by the second network node when the time lapsed between the first receipt time and a current time is equal to or greater than the overrun time.

The above method of processing request may be implemented in a network system. The network system may comprise a client terminal, a gateway, and a plurality of network nodes. Each of the network nodes may be a connection point inside a network system that can receive, send, create, or store data. Each node may require some forms of identification to receive access.

Exemplary network nodes may include computers, printers, gateways, modems, bridges, switches, clouds, etc. The client terminal may be implemented or formed in one of these network nodes. As an example of step (a), the client terminal may send a request to a corresponding gateway. The corresponding gateway may then process the request and may require service from one or more network nodes.

According to the preferred embodiment of the present invention, when a request has made, such request may be processed by a plurality of network nodes. For example, for a given network node, a request may be sent from an upstream network node. When the request has been processed by this given network node, the given network node may also transmit a request to the next network node (i.e. a downstream network node). For the sake of clarification, the request received by a particular network node is called “parent request”, while the request sent out by that particular network node is called “sub-request”. Thus, a request can be a parent request and a sub-request depending on whether or not it is received or sent by a given network node respectively.

For example, network node 1 may send a request 1 to network node 2. Request 1 may be received and processed by network node 2. After that, network node 2 may send a request 2 to network node 3. Request may then be received and processed by network node 2. In this scenario, the parent request for network node 2 is request 1, while the sub-request for network node 2 is request 2. Similarly, the parent request for network node 2 is request 2, while network node 2 does not send out any sub-request.

Moreover, network node 1 is an upstream node of network node 2, while network node 2 is a downstream node of network node 1. Similarly, network node 2 is an upstream node of network node 3, while network node 3 is a downstream node of network node 2.

Thus, in step (a), the first network node is an upstream network node of the second network node, the request received by the second network node is the parent request, while a request sent by the second network node is a sub-request.

In a network system, the first network node may be configured as a client terminal, while the second network node may be configured as a gateway or a service node in the network system.

In the preferred embodiment of the present invention, when the first network node is a client terminal or a gateway for other networks, the second network node may be configured as a gateway. On the other hand, when the first network node is a gateway of the present network or a service node, the second network node may be configured as a service node.

In step (a) mentioned above, the first request time may be time at which the parent requested is generated. For example, when the first network node generated a request at 8:20, and such request was sent to the second network node at 8:21, such request is the sub-request for the first network node and a parent request for the second network node, and the first request time is 8:20.

In step (b) above, the first remaining time is the remaining time for completing the parent request. In this preferred embodiment of the present invention, the first remaining time may be the time assigned for processing the parent request by the second network node, plus the time assigned for processing any sub-request of the parent request by any downstream network node. For example, when the second network node receives a parent request, and the first remaining time is 1 second. Suppose that parent request needs to be processed by a downstream network node as well. Then, this first remaining time includes the time for processing the parent request by the second network node and the processing of any sub-request of the parent request by the downstream network node (if necessary).

In the preferred embodiment of the present invention, the second network node may be configured as a gateway or a service node. If the second network node is configured as a gateway, the first remaining time may be pre-set and fixed by this gateway. If the second network node is configured as a service node, the first remaining time may be predetermined by an upstream network node. In other words, the parent request may include information about the first remaining time.

In step (c), the first overrun time may represent the maximum assigned time period threshold the parent request may be processed. When the parent request has been processed for more than the first overrun time, the processing of the parent request will be terminated. Moreover, the second network node will not generate any sub-request for the downstream network node. The first receipt time was the time the parent request was received by the second network node. The first receipt time is the start time of the first overrun time. When the first overrun time has lapsed from the first receipt time, the processing of the parent request will be terminated and the result of processing the parent request will be recorded, although the result may not be fully completed.

In this preferred embodiment of the present invention, each of the network nodes in the entire network system may be configured such that the time for processing each request may be counted and recorded so as to compare with the corresponding overrun time. For example, when network node 1 is processing a request, and this request involve sending a sub-request to network node 2. When a pre-set overrun time has lapsed from the receipt time of the request by network node 1, and network node 1 has not received any response from network node 2, the processing time of the sub-request received by network node 1 has overrun.

Step (c) may comprise the steps of:

subtracting the first request time from the first receipt time to define a first time difference; and

subtracting the first time difference from the first remaining time to define the first overrun time.

In other words, the first overrun time for a given network node, that is the time that the given node used for monitoring the progress of a request it is dealing with, is equal to first remaining time minus the first time difference, and this equals to the first remaining time minus the difference between the first receipt time and the first request time. That is,

first overrun time=first remaining time−first time difference=first remaining time−(first receipt time−first request time)

As an example, request 1 was generated by network node 1 at 8:20. Network node 1 may then transmit request 1 to network node 2 at 8:21. Network node 2 received request 1 and started processing request 1 at 8:26. Suppose that the first remaining time acquired by network node 2 was 100 second. In this example, request 1 constitutes parent request for network node 2, the first request time of the parent request was 8:20, while the first receipt time of the parent request was 8:26. The first remaining time was 100 seconds. Therefore, the first time difference is equal to the difference between the first receipt time and the first request time, which is 6 seconds. Moreover, the first overrun time is equal to the difference between the first remaining time and the first time difference, which is 100 seconds−6 seconds=94 seconds.

Moreover, when network node 2 requires the service of network node 3 when processing request 1, network node 2 may send out a sub-request to network node 3 as its downstream network node. As a result, the processing of the parent request involves the processing of the sub-request. Thus, the parent request cannot be successfully processed until the sub-request has been successfully processed and the response is sent back to network node 2.

Suppose network node 2 and network node 3 mentioned above may be designated as the second network node and the third network node, the sub-request sent by the second network node may carry a second request time and a second remaining time of the sub-request. The second request time is the time at which the sub-request was generated, while the second remaining time designates the processing time of the sub-request. With respect to the second network node, this sub-request from the second network node may constitute a parent request of the third network node. Moreover, the second overrun time may be the maximum assigned time for processing the sub-request and may also be determined by the third network node by difference between the second remaining time and the second time difference, where the second time difference may be determined by the difference between the second receipt time and the second request time. The second receipt time is the time at which the third network node receives the parent request (a sub-request with respect to the second network node and a parent request with respect to the third network node) from the second network node. Thus, the first overrun time may be greater than or equal to a sum of all second overrun time of all downstream network nodes.

It is worth mentioning that the third network node may be configured as a service node, wherein the second request time may refer to the time at which the sub-request was generated by the second network node. The second receipt time is the time at which the sub-request was received by the third network node. The second receipt time is also the start time at which the sub-request was processed and the third network node starts to count until it reaches the overrun time.

The second remaining time may be designated as the time for processing the sub-sequent sent by the second network node. Thus, the second remaining time may be determined by subtracting the time for processing the sub-request by the third network node and normal network delay from the first remaining time. As a result, the second remaining time is less than the first remaining time.

Specifically, the second remaining time may be determined by the steps of:

subtracting first request time from the second request time to generate a second time difference;

gathering normal network delay for the network system; and

subtracting the second time difference and the network delay from the first remaining time to obtain the second remaining time.

In other words, the second remaining time=first remaining time−(second receipt time−first receipt time)−network delay.

From the forgoing descriptions, one skilled in the art may appreciate that a remaining time of a given network node may be determined by the remaining time of an upstream network node minus the difference between the receipt time of the sub-request and the receipt time of the parent request and minus any network delay. In other words, the remaining time of each network node will become variable depending on the remaining time of the upstream network node. As such, this mechanism also ensures that the overrun time of a downstream network node depends on and less than the overrun time of an upstream network node. The result is to prevent a situation where the overrun time of an upstream network node has lapsed while the sub-request is still being processed by a downstream network node. When processing of the parent request has aborted, continuing processing the sub-request will be a complete waste of computing resources and should be avoided.

When the processing of the parent request by a given network node does not involve the use of any downstream network node, that given network node will not transmit any sub-request to any downstream network node, and determination of the second remaining time and the second overrun time will become unnecessary.

In the preferred embodiment of the present invention, the network delay may depend on the corresponding network environment. A typical network delay may be pre-designated as around 5 ms. Alternatively, the network delay may be determined according to actual network environment, and may not need to be pre-set.

In step (d), when the time for processing by the second network node has been greater than the overrun time, this means the maximum allowable time for processing the parent request has lapsed. The processing of the parent request should be aborted. The abortion of request processing will be fed back to the first network node as a corresponding timeout signal so as to let the first network node know that the processing of the parent request has been aborted.

When processing of the parent request requires the use of sub-requests, the processing time of each of the sub-requests may not be greater than the overrun time. If the processing time of a given sub-request is greater than the corresponding overrun time, the processing of the sub-request may be aborted, and the abortion of sub-request processing may be fed back to the upstream network node as a corresponding timeout signal, and the processing of the parent request will also be terminated.

For example, a given parent request may be processed in three separate and sequential steps, namely step 1, step 2 and step 3. When step 1 has been executed, the system may determine whether or not the time for processing step 1 exceeded the overrun time. If that is the case, the processing of the parent request will be aborted. If not, step 2 will then be executed. When step 2 has been executed, the system may determine whether or not the total time for processing step 1 and step 2 exceeded the overrun time. If that is the case, the processing of the parent request will be aborted. If not, step 3 will then be executed. When step 3 has been executed, the system may determine whether or not the total time for processing step 1 through step 3 exceeded the overrun time. If that is the case, the processing of the parent request will be aborted. If not, the parent request will have successfully processed within a targeted timeframe.

From the forgoing descriptions, one may also appreciate that the second remaining time may determine whether or not a sub-request may be sent from the second network node to the third network node. For example, when the second remaining time is less than or equal to zero, the second network node is configured not to send sub-request to a downstream network node, such as the third network node.

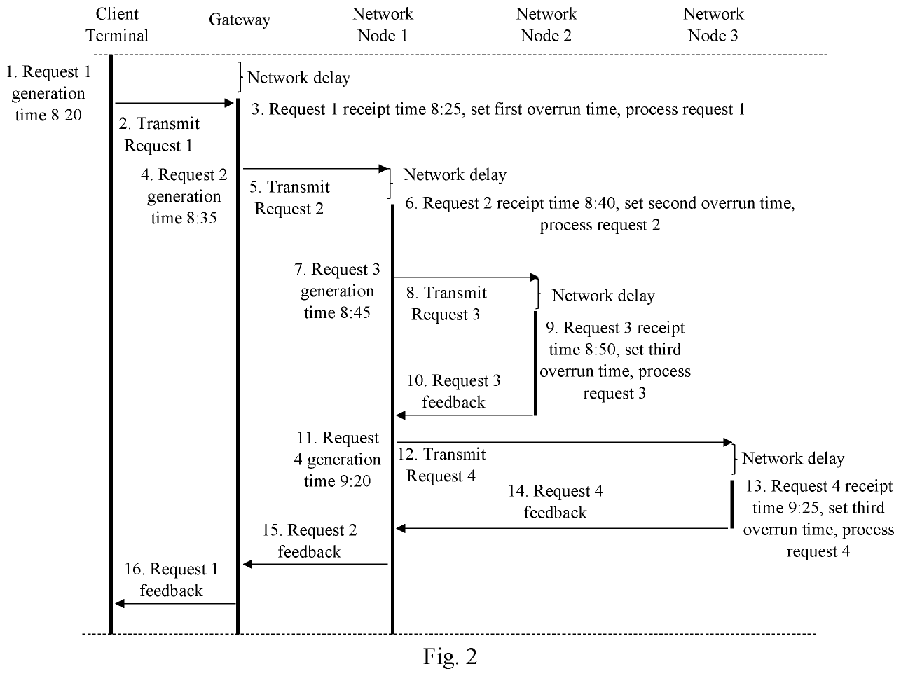

The method of processing requests may be illustrated in FIG. 2 of the drawings. The steps are as follows:

Step (1): the client terminal generates request 1 at the time 00:08:20 as the first request time.

Step (2): the client terminal sends request 1 to a gateway, wherein request 1 contains information of the first request time, which is 00:08:20.

Step (3): the gateway receives request 1 at 00:08:25 as the first receipt time, the first remaining time configured by the gateway is 100 s. The gateway starts processing request 1, and the first overrun time may be determined by first remaining time−(first receipt time−first request time)=100 s−(00:08:25−00:08:20)=100 s−5 s=95 s.

Step (4): the gateway may require the service of network node 1 and generate a request 2, wherein the second request time may be recorded as 00:08:35.

Step (5): the gateway may send request 2 to network node 1, wherein request 2 includes information regarding second request time which is 00:08:35, and a second remaining time for request 2 of 80 s, wherein the second remaining time may be determined by the first remaining time−(second request time−first request time)−network delay=100 s−(00:08:35−00:08:20)−5 s=80 s, in which the network delay may be configured as 5 s.

Step (6): network node 1 receives request 2 at 00:08:40 and determines the second overrun time for network node 1, wherein the second overrun time may be determined by the second remaining time−(second receipt time−first request time)=80−(00:08:40−00:08:20)=80 s−20 s=60 s. Network node 1 may then go on to process request 2.

Step (7): Network node 1 may receive a response signal of request 2 within the 60 s overrun time limit (the second overrun time) and continue processing request 2. Processing request 2 may require the service of a downstream network node such as network node 2. As a result, request 3 may be generated by network node 1. An exemplary third request time (for request 3) may be generated at 00:08:45.

It is worth mentioning that when network node 1 does not receive any response signal for request 2 within the timeframe permitted by the second overrun time, the processing of request 2 may extend beyond the second overrun time and the entire processing will be aborted. The service of network node 2 will not be required. The timeout signal will then be fed back to the gateway as well.

Step (8): network node 1 send request 3 to network node 2, wherein request 3 include information regarding third request time, which is 00:08:45, wherein the third remaining time may be determined by the second remaining time−(third request time−second request time)−network delay=80 s−(00:08:45−00:08:35)−5 s=80 s−10 s−5 s=65 s, in which the network delay may be configured as 5 s.

Step (9): network node 2 receives request 3 at 00:08:50, and determines the third overrun time for network node 2, wherein the third overrun time may be determined by the second remaining time−(third receipt time−second request time)=65 s−(00:08:50−00:08:35)=65 s−15 s=50 s. Network node 2 may then go on to process request 3.

Step (10): within the third overrun time, network node 2 sends response signals back to network node 1 for successfully processing request 3.

Step (11): network node 1 receives the response signals sent from network node 2, and requests the service of network node 3, and generate request 4 at 00:09:20.

Step (12): network node 1 sends request 4 to network node 3, wherein request 4 includes a fourth request time of 00:09:20, wherein the fourth remaining time may be determined by second remaining time−(fourth request time−second request time)−network delay=80 s−(00:09:20−00:08:35)−5 s=30 s.

Step (13): network node 3 receives request 4 at 00:09:25, and determines the fourth overrun time for network node 3, wherein the fourth overrun time may be determined by the second remaining time−(fourth receipt time−second request time)=80 s−(00:09:25−00:08:35)=80 s−50 s=25 s. Network node 2 may then go on to process request 4.

(Step 14): network node 3 completes processing of request 4 within the fourth overrun time and send a response signal back to network node 1.

It is worth mentioning that if network node 3 cannot complete processing of request 4 within the fourth overrun time, the processing of request 4 will be aborted and a corresponding response signal will be sent back to network node 1.

Step (15): network node 1 receives a response signal of request 4 and continue processing request 2 within the second overrun time, and send a response signal back to gateway.

Step (16): the gateway receives a response signal of request 2 and continues processing request 1 within the first overrun time, and send a response signal back to the client terminal.

If, after the first overrun time has lapsed, and the gateway could not successfully process request 1, the processing time has become overrun, and the corresponding response representing unsuccessfully processing due to time running out will be sent back to the client terminal by the gateway. Conversely, if, within the assigned overrun time, the gateway could successfully process request 1, the corresponding response signifying successful process will also be sent back to the client terminal.

From the forgoing descriptions, one skilled in the art may appreciate that the second overrun time for processing request 2 by the network node 1 is 60 s, while the first overrun time for processing request 1 by the gateway is 95 s. Thus, the gateway may receive a response signal from network node 1 before the second overrun time has lapsed. This mechanism ensures that no overrun occurs, sub-requests will not processed anymore, thus saving substantial computing resources.

In the example illustrated in FIG. 2 of the drawings, in the example illustrated in FIG. 2 of the drawings, with respect to network node 1, request 1 is a parent request of request 2. With respect to network node 2 and network node 3, request 2 is a parent request of request 3 and request 4.

As such, according to the above method of processing requests, each of the network node may determine a corresponding overrun time by reference to a request time and a remaining time of a parent request, so that an overrun time of an upstream network node may be greater than that of a downstream network node. As such, the overrun time for all network nodes may gradually decrease. Moreover, the remaining time for each of the network node may depend on the remaining time, a request time of a parent request sent by a corresponding upstream network node, and network delay. These ensure that all sub-requests may be successfully processed before the overrun time of the parent request has lapsed. In the situation where the processing time of the parent request has overrun, the above method ensures that processing of all sub-requests have been aborted before at the time the overrun time of the parent request lapses, so that no computing resources will be wasted for processing sub-requests originating from a parent request the processing of which has been aborted.

It is worth mentioning that the above-mentioned method may be accomplished by software, hardware or a combination thereof. The software may be implemented in a computing device for executing the above-mentioned steps. The software may also be executed in a local computer through a wired or wireless network with the help of a server. The computing device may be a computer, a tablet computer, or even a smart phone. The computing device may broadly comprise a processor, a storage medium and a display. Examples of storage mediums may include a hard drive, a solid-state drive, a DVD, etc.

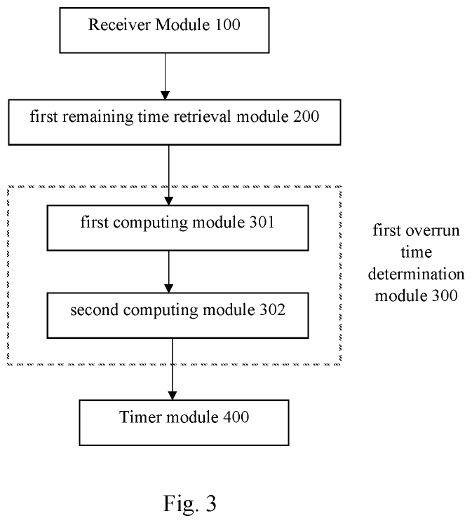

Referring to FIG. 3 of the drawings, the above-mentioned steps may be carried out by a request processing system, comprising:

a receiver module 100 configured to receive a parent request, the parent request including a first request time;

a first remaining time retrieval module 200 connected to the receiver module 100, the first remaining time retrieval module 200 may be configured to determine a first remaining time which is the time left for processing the parent request;

a first overrun time determination module 300 connected to the receiver module 100 and the first remaining time retrieval module 200, wherein the first overrun time may be configured to determine a first overrun time according to a first request time, the first remaining time and a first receipt time of the parent request; and

a timer module 400 connected to the first overrun time determination module 300, the receiver module 100, and the first remaining time retrieval module 200, wherein the timer module 400 is configured to abort processing of the parent request when the time lapsed between the first receipt time and a current time is equal to or greater than the first overrun time.

According to the preferred embodiment of the present invention, the first overrun time determination module 300 may comprise:

a first computing module 301 configured to determine the result of subtracting a first request time from a first receipt time of a parent request to get a first time difference; and

a second computing module 302 configured to determine the result of subtracting the first time difference from the first remaining time to get the first overrun time.

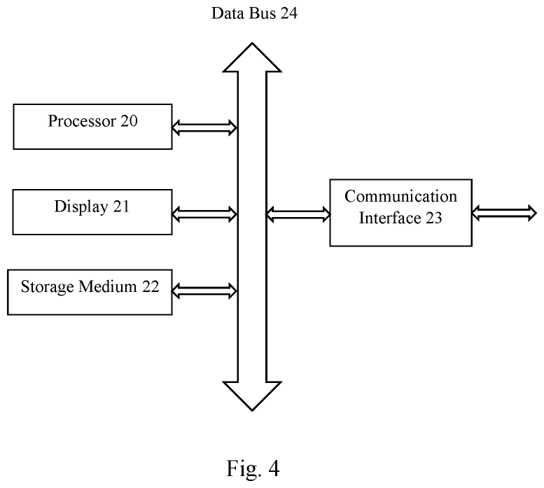

Referring to FIG. 4 of the drawings, the network system implementing the above-mentioned steps is illustrated. The network system may comprise at least one processor 20, a display 21, a storage medium 22, a communication interface 23, and data buses 24. The processor 20, the display 21, the storage medium 22, and the communication interface 23 may be communicated though the data buses 24. The display 21 such as a monitor may provide an interface for visually illustrating a user interface. The processor 20 may execute commands or programs stored in the storage medium 22. Examples of the storage medium 22 are described above.

The storage medium 22 may be configured to storage programs for executing the above-mentioned method, and a relevant database. Thus, the storage medium 22 may be configured as a hard disk, a portable hard drive, a Read-Only-Memory (ROM), Random Access Memory (RAM), or DVD etc.

The present invention, while illustrated and described in terms of a preferred embodiment and several alternatives, is not limited to the particular description contained in this specification. Additional alternative or equivalent components could also be used to practice the present invention.

What is claimed is:

1. A method of processing request for a network system, comprising the steps of:
(a) receiving a parent request by a second network node from a first network node, said parent request including a first request time, said first request time being a time at which said parent request is generated;
(b) acquiring a first remaining time by said second network node, said first remaining time being a time left for processing said parent request;
(c) determining a first overrun time by said second network node, said first overrun time being an assigned time determined by said first request time, said first remaining time and a first receipt time of said parent request, said first receipt time being said time said parent request is received by said second network node, and
(d) aborting processing of said parent request by said second network node when a time lapsed between said first receipt time and a current time is equal to or greater than said overrun time, said first overrun time being a time period threshold that said parent request is processed.

2. The method, as recited in claim 1, wherein said step (c) comprises the steps of:
subtracting said first request time from said first receipt time to define a first time difference; and
subtracting said first time difference from said first remaining time to define said first overrun time.

3. The method, as recited in claim 2, further comprising a step of sending a request by said second network node to a third network node to request a service therefrom, said request sent from said second network node being a sub-request with respect to said second network node, and at the same time a parent request with respect to said third network node.

4. The method, as recited in claim 3, wherein said sub-request sent by said second network node carries a second request time and a second remaining time of said sub-request, said second request time is a generation time of said sub-request, while said second remaining time designates a processing time of said sub-request, wherein with respect to said second network node, said sub-request from said second network node constitutes a parent request of said third network node.

5. The method, as recited in claim 4, further comprising the steps of:
subtracting said first request time from said second request time to define a second time difference;
gathering normal network delay for said network system; and
subtracting said second time difference and said network delay from said first remaining time to obtain said second remaining time.

6. The method, as recited in claim 5, further comprising the steps of, before sending a sub-request by said second network node to said third network node, and when said second remaining time is equal to or less than zero, confirming that said first overrun time is lapsed.

7. The method, as recited in claim 6, further comprising the steps of sending a timeout signal from said second network node to said first network node when said second network node receives a timeout signal from said third network node.

8. The method, as recited in claim 7, wherein each of said first through third network node comprises at least one of a client terminal, a gateway, and a connection point in a network system.

9. The method, as recited in claim 8, wherein said network delay is pre-designated in said network system.

10. A request processing system, comprising:
a first network node configured to generate and transmit a parent request; and
a second network node communicated with said first network node, said second network node being configured to:
receive a parent request transmitted from said first network node, said parent request including a first request time, said first request time being a time at which said parent requested is generated;
acquire a first remaining time, said first remaining time being said time left for processing said parent request;
determine a first overrun time, said first overrun time being determined by said first request time, said first remaining time and a first receipt time of said parent request, said first receipt time being said time said parent request is received by said second network node; and
abort processing of said parent request when a time lapsed between said first receipt time and a current time is equal to or greater than said overrun time, said first overrun time being a time period threshold that said parent request is processed.

11. The request processing system, as recited in claim 10, wherein each of said first network node and said second network node comprises at least one of a computer, a gateway, a modem, a client terminal, and a network service node.
